(19) United States
(12) Patent Application Publication
(10) Pub. No.: US 2009/0302680 A1
(43) Pub. Date: Dec. 10, 2009

(54) DISTRIBUTED PHOTOVOLTAIC POWER GENERATION SYSTEM

(76) Inventors: Kent Kernahan, Cupertino, CA (US); David C. Buuck, Santa Clara, CA (US); Sorin Andrei Spanoche, Cupertino, CA (US)

Correspondence Address: MICHAEL W. CALDWELL, 4226 RIVERMARK PARKWAY, SANTA CLARA, CA, 95054-4150, US

(21) Appl. No.: 12/195,459

(22) Filed: Aug. 21, 2008

Related U.S. Application Data
(60) Provisional application No. 61/028,985, filed on Feb. 15, 2008.

(51) Int. Cl. H02J 1/10

(52) U.S. Cl. 307/43

(57) ABSTRACT

Power is provided to one or more loads by a photovoltaic power generating system wherein the system provides alternating current. No direct current connection is required, allowing the system to be collocated with a load.

### CROSS REFERENCES TO RELATED APPLICATIONS

This application is related to commonly-owned U.S. Provisional Patent Application Ser. No. 61/028,985, titled ARRAY OF DISTRIBUTED INVERTERS FOR MANAGING THE POWER OF MULTIPLE SOLAR PANELS AND METHODS OF USING filed Feb. 15, 2008, by Kernahan, et al. In addition, this application is related to the commonly-owned U.S. Nonprovisional application Ser. No. 12/061,025 filed Apr. 2, 2008 by Kernahan, et al, titled DISTRIBUTED MULTIPHASE CONVERTERS. Both related applications are incorporated herein in their entirety.

### BACKGROUND

Medium to large capacity centralized energy generation systems based upon photovoltaic (PV) conversion are a new system for commercial and utility applications. In the 100 kW peak and larger system size, presently ranging into the hundreds of megawatts peak capacity, systems are largely based upon scaled-up versions of smaller, residential-style distributed PV generations systems, typically of 1 to 10 kW peak capacity each. The system taxonomy across this wide dynamic range of applications is largely the same. These systems are based upon individual PV modules, each comprised of multiple PV cells in a series circuit, wherein each of the modules is then placed in a larger series circuit to form a unit known as a “string”. Multiple strings are directly wired together in parallel circuits, using passive connection units known as “combiner boxes”. Ultimately, the direct-current (DC) network formed is called an “array”. The output of such an array is connected to an inverter, a power conversion unit which transforms the DC output of the insolated array into a form compatible with connection and summation to an alternating current (AC) electricity distribution grid. This architectural sub-centralization of both the DC generating elements (the PV array) leads to power losses such that the power conversion unit (the inverter) necessitates scaling each system element for higher capacity, giving rise to very large DC arrays, partitioned into sub-arrays as a function of the largest inverter capacity available. Today, such large commercial-scale inverter capacities range from 100 kW to 1 megawatt (MW) capacity. Typical inverters cannot tolerate high temperature and must also be protected from weather. Large capacity inverters are large and heavy, requiring significant structures (such as poured-concrete mounting pads and weather shelters) to make them mechanically safe and reliable. Some inverters require environmental cooling. This in turn drives the requirement to centrally locate, or locate in centralized clusters, one or more inverters, which in turn drives the requirement for extended DC feed lines from the array to the inverter, ground-mounting of the inverter (in the case of building-integrated rooftop PV generating systems), and subsequent extended AC output cabling to connect the output of such a system to the AC mains point of interconnect (“POI”).

In a typical installation, a PV array is located on the roof of a commercial structure. For reasons stated previously, an inverter(s) is located at ground level. The mains from the grid, including the power meter, are also brought to the building at ground level and connected to the ground-level inverter. The result is very long runs of wire from the roof down to ground level to connect the DC array output to the inverter. Due to a very high current of perhaps several hundred amperes and a long run of the DC wiring to the inverter (often several hundred feet), the DC wiring must be of an extremely large gauge wire bundle with low resistance. Due to the size and weight of the inverter(s) it is not practical to locate the inverter on the roof where the high power equipment (load) is located. What is needed is an arrangement wherein a system providing high voltage, high current AC may be collocated with equipment that demands high power, for example HVAC equipment, thereby diminishing the cost, size, weight, and labor-intensive installation of high-capacity wiring bundles.

### SUMMARY

In the invention disclosed in hereinbefore referenced U.S. application Ser. No. 12/061,025 (“the '025 application”), a DC to pulse amplitude modulated (“PAM”) current converter, denominated a “PAMCC”, is connected to an individual solar panel (“PV”). A solar panel typically is comprised of a plurality, commonly seventy-two, individual solar cells connected in series, wherein each cell provides approximately 0.5 volt at some current, the current being a function of the intensity of light flux impinging upon the panel. The PAMCC receives direct current (“DC”) from a PV and provides pulse amplitude modulated current at its output. The pulse amplitude modulated current pulses are typically discontinuous or close to discontinuous with each pulse going from near zero current to the modulated current and returning to near zero between each pulse. The pulses are produced at a high frequency relative to the signal modulated on a sequence of pulses. The signal modulated onto a sequence of pulses may represent portions of a lower frequency sine wave or other lower frequency waveform, including DC. When the PAMCC's output is connected in parallel with the outputs of similar PAMCCs an array of PAMCCs is formed, wherein the output pulses of the PAMCCs are out of phase with respect to each other. An array of PAMCCs constructed in accordance with the present invention form a distributed multiphase inverter whose combined output is the demodulated sum of the current pulse amplitude modulated by each PAMCC. If the signal modulated onto the series of discontinuous or near discontinuous pulses produced by each PAMCC was an AC current sine wave, then a demodulated, continuous AC current waveform is produced by the array of PAMCCs. This AC current waveform is suitable for use by both the “load”, meaning the premises that is powered or partially power by the system, and suitable for connection to a grid. For example, in some embodiments an array of a plurality of PV-plus-PAMCC modules are connected together to nominally provide three-phase, Edison system 60 Hz 480 volt AC power to a commercial building.

Notably, the system disclosed in the '025 application does not require an inverter. The PAMCC modules each contribute current out of phase with each other directly to the common system output terminals, thereby providing useable power at the output terminals without an inverter, therefore without long DC wiring.

### BRIEF DESCRIPTION OF THE DRAWINGS

FIG. 1 is an example of a typical commercial solar power system, including an inverter. PRIOR ART.

FIG. 2 is an example of an embodiment of the present invention, providing commercial-class power to HVAC units on the roof of a building.

### DETAILED DESCRIPTION OF THE INVENTION

Definition of some terms:

| | |
|---|---|
| Grid | AC power provided to a premises by an outside source, typically a utility |
| | company. |
| PV | Photovoltaic panel; another term for the commonly-used “solar panel” |
| cps | Abbreviation for “cycles per second”; the frequency of an AC power supply |
| AC | Abbreviation for “alternating current”, though one may also view it as |
| | “alternating voltage” in that the polarity of the voltage provided alternates. |
| DC | Abbreviation for “direct current”; electrical power that is always provided in |
| | a given polarity. The voltage of the power source may or may not be fixed. |
| PAM | Pulse Amplitude Modulation. a form of signal modulation where the |
| | message information is encoded in the amplitude of a series of signal |
| | pulses. |
| PCM | Pulse Code Modulation. a digital representation of an analog signal where |
| | the magnitude of the signal is sampled regularly at uniform intervals, then |
| | quantized to a series of symbols in a digital (usually binary) code. |
| Combiner | An electrical connection apparatus comprising materials having low |
| box | electrical resistance wherein multiple electrical power sources are |
| | connected in common to provide a single source of power equal to the |
| | summation of the individual power sources. |
| POI | Point of Interconnect. Refers to the connection of a structure's electrical |
| | system to a grid, typically also the location of a power meter. |
| Array | A power converter module for controlling an individual PV panel in |
| converter | cooperation with other similar power converter modules as disclosed in U.S. |
| | patent application 12/061,025. |
| ACPV | Array Converter Photo Voltaic module; a solar panel including an |
| | array converter incorporated therein. |
| ADC | DC amperes. |
| VAC | Alternating current voltage. |

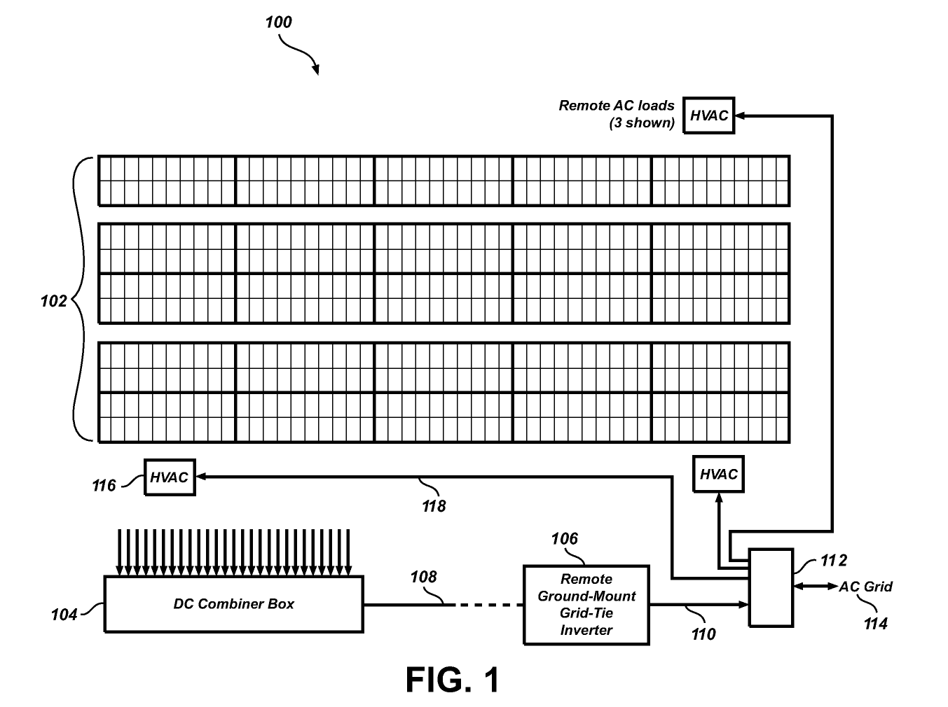

FIG. 1 illustrates a typical installation of a PV-based power generation system on the roof of a structure, such as a commercial building. The same arrangement is typical of a residential system installation, though a residential system would usually provide two-phase power and a single inverter. An array of PV panels 102 provide high voltage, high current DC electricity to a DC combiner box 104. The combiner box 104 may be located near the solar panel array 102, though collocation is not required. An inverter 106 receives the DC from the DC combiner box 104 on a line 108. The line 108 is often very heavy-duty. For example, a typical design would require twenty-five strings of 10AWG wire running one hundred feet, carrying a total of 280 ADC for five hundred feet (roof to ground). Such a cable 108 would weight approximately 1,400 pounds (if made from copper wire), and suffer a 4% loss, including connectors. The inverter 106 is connected to the AC point of interconnect 112 by a line 110. Depending upon the power provided by the PV system 110 and the power required by the load, such as a HVAC unit 116, the system 110 may provide all the power needed by the load 116 with any excess being driven into the gird 114. Any shortfall of the system 100 compared to the power needs of the load 116 is provided by the grid 114 through the POI 112. The POI 112 provides power (from either the system 100 or the grid 114) to the load 116 on a line 118. The design shown in FIG. 1 is just an example. Note that all three illustrated HVAC loads 116, 120, 122 are powered from the same point. As-shown, there is a single inverter 106, though another design may provide for more inverters, each with its own down-wire 108 to keep current density down. An installation may include more or fewer array panels 102, longer or shorter DC wiring 108, one or more than one inverter 110, and clearly more loads may be serviced.

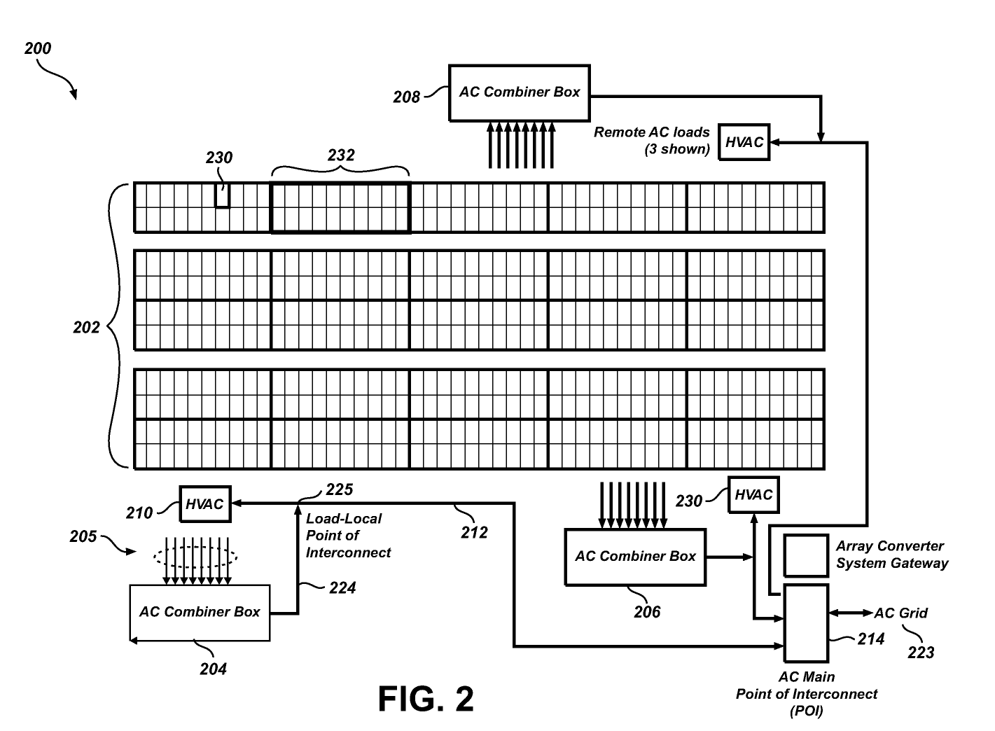

Looking to FIG. 2, a system 200 according to the present invention is shown in an example embodiment. A plurality 202 of array converter photovoltaic modules 230 are located on a roof for good sunlighting. In one embodiment ten ACPVs 230 are combined to form a cluster of ACPVs 230 denominated a “pod” 232 (for example). Further, in some embodiments twenty-five pods 232 are combined to form a group denominated a “group” 220, wherein a group 202 may provide approximately 100 KW of peak energy. For the purpose of illustration, consider a group 202 wherein the group 202 has sub-sections connected to an AC combiner box. As shown—the AC lines from nine pods 232 are connected to an AC combiner box 204, another (different) nine pods are connected to another AC combiner box 206, and eight pods 232 are connected to a third AC combiner box 208. In any given design there may be more or fewer pods 232 connected to an AC converter box, more or fewer loads, and such. First we look to a single load, for example an HVAC unit 210. The AC lines 205 from eight pods 232 are electrically connected to an AC combiner box 204. AC combiner boxes 204 are sometimes simply heavy-duty bus bars enclosed in a water proof housing, including water proof connectors. Each pod 232 provides approximately 480 VAC at 6 ADC in a three-phase delta electrical configuration. The power from the nine pods 232 are provided at a terminal to power lines 224 which carry the electrical power from the AC combiner box 204 directly to the HVAC load, through a local point of interconnect 225. The pods 232, combiner box 204, local POI 225, and load 210 may all be located very close together. Note that there is no long wire (similar to 108, FIG. 1) because the pods 232 each provide AC power directly. Similarly other pods may be connected to other AC combiner boxes 206, 208 to provide power to other loads 220, 230 in a similar fashion. Note that each “pod line”, for example the pod lines 205, comprises AC power in the number of phases desired. For example, as illustrated in FIG. 2, each pod line comprises four wires (three phases plus neutral).

In an embodiment similar to that in FIG. 2, wherein the FIG. 2 embodiment may be compared to the present art shown in FIG. 1, only 14AWG wire is needed for connecting pods 232 to AC combiner boxes 204, 206, 208. It is estimated that only one hundred fifty pounds of copper wire are needed for the installation, and the loss from wire links is approximately five percent.

The system is, as in FIG. 1, connected to an AC main POI 214, and wire return from the POI 214 point to the loads for backup power, for example at night. In some embodiments a system according to the present invention is retrofitted on an existing building, already wired conventionally. In that case, the POI will still be at ground level. In new building construction, with ground installation no longer required (for an inverter(s)), the AD grid 223 may be brought t the POI 214 at a roof location, thereby saving the long AC wiring path from the ground to the HVAC loads on the roof, as was

Operational measurement of time-correlated AC voltages, currents, and temperatures enables automated metering of energy delivered. In some embodiments the POI 214 includes means for measuring the voltage at the POI 214. The ACPVs 230 all measure their current output and communicate the value of their current through the pod 232 wiring 205 to the AC combiner box 204. The communication signals are provided to the POI 214 on lines 224, 212. Various methods for the communication are discussed more fully in the '025 application. With the total current known and the voltage measured at the POI 214, the power delivered by the system 200 may be found by the product of the RMS values of the reported current and the measured voltage.

The present invention can be seen to provide several benefits, for example:
a. Eliminate all DC wiring in commercial and utility PV systems (an intrinsic byproduct of the technology);
b. Enable multiple points of interconnect to the AC mains utility grid, eliminating normally required additional feed-in AC wiring cost, labor, and importantly, operational losses;
c. Enable, in certain applications, direct connection of the PV system output to local loads that consume the most energy when the PV system has the highest output, for example a PV system connected to an air-conditioning unit on a sunny day; and
d. Enable precision measurement of interconnection current-resistance product losses (known as tare loss), and properly metering and accounting for these losses dynamically, in real time.

### Resolution of Conflicts

If any disclosures are incorporated herein by reference and such incorporated disclosures conflict in part or whole with the present disclosure, then to the extent of conflict, and/or broader disclosure, and/or broader definition of terms, the present disclosure controls. If such incorporated disclosures conflict in part or whole with one another, then to the extent of conflict, the later-dated disclosure controls.

What is claimed is:

1. A system providing electrical power, comprising:
a plurality of array converter photovoltaic modules, wherein the array converter photovoltaic modules include terminals providing alternating electrical current to lines, wherein the line are electrically connected in parallel;
an alternating-current combiner box electrically connected to the lines wherein the alternating-current combiner box receives electrical current provided by the array converter photovoltaic modules and provides combined current at output terminals of the alternating-current combiner box;
and lines for carrying electrical power generated by the array converter photovoltaic modules to a load.

2. The system of claim 1, further including means for electrically connecting the load to an alternating-current grid.

3. The system of claim 2, wherein the grid is three-phase electricity.

4. The system of claim 2, wherein the grid is two-phase electricity.

5. The system according to claim 2, wherein the means for connecting the load to the alternating-current grid further includes means for measuring voltage at a point of interconnection.

6. The system according to claim 5, wherein each of the array converter photovoltaic modules further includes means for measuring the current provided by each array converter photovoltaic module and wherein the value of the current is provided to a means for measuring voltage at a point of interconnection.

7. The system according to claim 6, wherein the power provided by the system is found by multiplying the value of the current times the voltage.
